(19) United States
(12) Patent Application Publication
(10) Pub. No.: US 2008/0066367 A1
(43) Pub. Date: Mar. 20, 2008

(54) FISH DETECTOR

(76) Inventors: Glenn Meeks, Ocala, FL (US); Dennis Spruil, Orlando, FL (US)

Correspondence Address: SCHWEGMAN, LUNDBERG & WOESSNER, P.A., P.O. BOX 2938, MINNEAPOLIS, MN, 55402, US

(21) Appl. No.: 11/738,250

(22) Filed: Apr. 20, 2007

Related U.S. Application Data
(60) Provisional application No. 60/745,357, filed on Apr. 21, 2006.

(51) Int. Cl. A01K 97/12

(52) U.S. Cl. 43/17

(57) ABSTRACT

A fishing device is shown with a number of advantages. A fishing line is not coupled to the device, thus providing ease of use, and improved casting ability. A vibration sensor is used to detect only fish. The vibration sensor can ignore extraneous motion such as waves, bait, etc. A fishing device is shown that provides multiple states of fish activity such as normal, currently striking, and missed strike. Further, a fish activity state can be transmitted to a remote device thus giving the fisherman more freedom to move about while the rod is left unattended.

### PRIORITY OF INVENTION

This non-provisional application claims the benefit of priority under 35 U.S.C. §119(e) to U.S. Provisional Patent Application Ser. No. 60/745,357, filed Apr. 21, 2006, which is herein incorporated by reference.

### TECHNICAL FIELD

This application relates generally to fish detection devices and, more particularly, to electronic devices to monitor fish bite activity and signal a user that fish bite activity has occurred.

### BACKGROUND

It is common while fishing to put a line in the water with bait and a hook and leave the line unattended for a length of time. This allows a fisherman to socialize or perform other activities while still having an opportunity for a fish to take the bait. However, if a fisherman is not closely watching the line, a fish may strike, nibble, or otherwise move the fishing line without the fisherman knowing.

There have been previous attempts at fish detection devices. For example, in ice fishing, a tip up fishing rod uses a mechanical spring loaded device with a flag to indicate when a fish has moved the fishing line. Electronic fish detection devices also exist, but current electronic detection systems have a number of drawbacks. They require that a sensor be attached directly to the line, which can be cumbersome. Additionally, current designs do not provide the fisherman with enough information and the information provided could be communicated more effectively.

What is needed is an improved fish detection device that solves some or all of the drawbacks of past designs.

### BRIEF DESCRIPTION OF THE DRAWINGS

FIG. 1 shows an isometric view of a fish detection device according to an embodiment of the invention.

FIG. 2 shows a side view of a fishing pole using a fish detection device according to an embodiment of the invention.

FIG. 3 shows a block diagram of a remote monitoring device according to an embodiment of the invention.

### DETAILED DESCRIPTION

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, electrical or logical changes, etc. may be made without departing from the scope of the present invention.

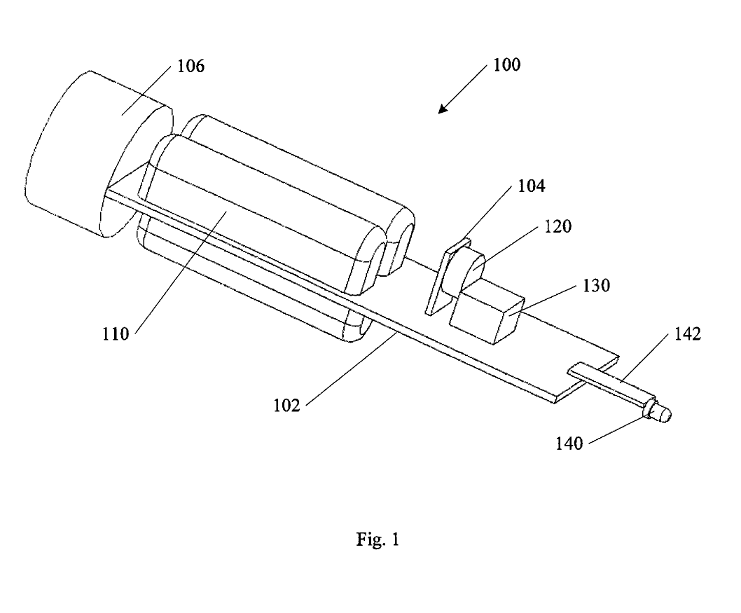

FIG. 1 shows a fish detection device 100 according to an embodiment of the invention. A base portion 102 such as a circuit board is included in the fish detection device 100. Batteries 110 are shown to provide power to circuits and other elements of the fish detection device 100. A circuit chip 120 is shown coupled to the base portion 102. A number of circuit functions are included within the circuit chip 120.

In one embodiment, the circuit chip 120 is coupled to a motion sensor 130. In one embodiment, the motion sensor 130 includes a vibration sensing circuit. Vibration sensors such as harmonic vibration sensors are unique due to the fact that they use frequency waves generate by a fish strike or bite that is analyzed by the processor to react on. In one embodiment, the vibration sensor does not touch the line or use a lever or any other device to monitor the line. This allows instant reaction time for the fisherman and easy casting by virtue of optional mounting on the bottom not the tip of the rod. In one embodiment, the vibration sensor signal is processed, and a program is included to selectively monitor specific frequencies or frequency ranges. As a result, extraneous rod and/or line motion can be ignored, and only fish strikes or bites are monitored. For example, in one embodiment, large waves from the water will not trip the unit and larger baits may be used like live four inch fish baits without confusing the vibration sensor and indicating a false strike.

In one example, a vibration sensor 130 includes a digital vibration sensor. In one embodiment, a digital vibration sensor monitors frequencies, and not magnitude of line vibrations. One advantage of frequency monitoring includes a simplified circuit detection program that does not require analog tuning to detect a particular gain associated with a fish strike.

In one example, a vibration sensor includes one or more ball bearings designed to move under a predetermined G-force. In one embodiment, three ball bearing are used to form a vibration sensor, where each ball bearing is capable of making or breaking a circuit to provide frequency detection data. In one embodiment, the digital data of the vibration sensor is constantly monitored. In another embodiment, the digital data of the vibration sensor is sampled at a selected rate to provide frequency data to indicate whether or not a fish strike/bite is taking place.

In one embodiment, the circuit chip 120 includes an output signal generator 104. The output signal generator 104 is used to send a signal to devices that provide the fisherman with visual, audible, tactile, etc. feedback as to the status of fish activity. Output alert devices triggered by the output signals will be discussed in more detail below.

In one embodiment, the output signal generator 104 includes a transmitter or transceiver signal generator. The transmitter or transceiver signal generator is used to send a signal to an optional remote device such as a key fob, or other portable device to be carried by the fisherman. One example of a remote device 300 is shown in block diagram form in FIG. 3, and will be discussed in more detail below. As mentioned above, in one embodiment, transmitted signals include feedback as to the status of fish activity that will be relayed to the fisherman through the remote device 300. In one embodiment, the fisherman is alerted both through the remote device and through at least one alert device located on the fish detection device 100.

Examples of alert devices are shown in FIG. 1, although the examples are not exhaustive. An audible sound generation device 106 such as a piezo-electric buzzer is shown coupled to the base portion 102. A visual light generation device such as a light emitting diode (LED) 140 is also shown coupled to the base portion 102. In one embodiment a circuit board extension 142 is used to mount the LED 140. In one embodiment multiple LED devices with different colors are used to signal various status of fish activity.

A transmitter 104 is shown coupled to the base portion 102. In one embodiment the transmitter 104 is part of a transceiver, and can both send and receive signals from a remote device. In one embodiment the transmitter 104 sends signals generated at the circuit chip 120 such as feedback as to the status of fish activity to the remote device. At the remote device, alerts are conveyed to the fisherman using visual, audible, tactile, etc. feedback. Alert devices may include piezo-electric buzzers and LED's etc.

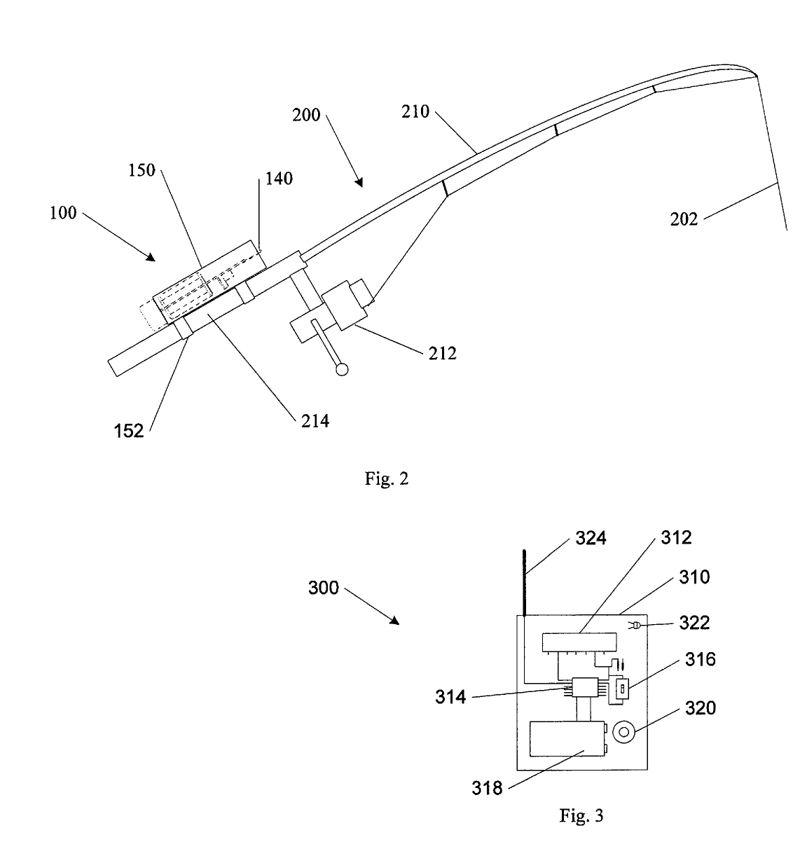

A suitable rod connection fitting is included in selected embodiments. One example of a rod connection fitting includes hook and loop fastener bands 152 as illustrated in FIG. 2, although the invention is not so limited. Other embodiments include screws, fittings, adhesives, or other fasteners, etc. The embodiment shown in FIG. 1 is adapted to attach along side a portion of a fishing rod or rod handle as illustrated in FIG. 2.

FIG. 2 shows the fish detection device 100 from FIG. 1 in an example use on a fishing rod 200. The fishing rod includes a flexible shaft 210, a reel 212 and a handle 214. A fishing line 202 is shown strung from the reel 212 along the flexible shaft 210.

An embodiment of a fish detection device 100 is shown coupled to a handle 214 of the fishing rod 200. One advantage of attaching to a handle includes the ability to cast with the fish detection device 100 remaining attached to the fishing rod. No detection elements are attached to the distal end of the rod, thus further providing a natural casting feel.

A casing 150 is shown covering elements of the fish detection device 100 as described in FIG. 1. In one embodiment, the casing 150 provides a watertight seal around elements of the fish detection device 100. This provides an obvious advantage of protection to electronic circuitry, etc. of the fish detection device 100 in the naturally wet environment of fishing. In one embodiment, a magnetic switch is included in the fish detection device 100 to turn the power on and off. One advantage of a magnetic switch includes the ability to make the casing 150 watertight without any switch elements protruding through the casing 150. The LED or other visual indicator 140 is visible through the casing 150.

In operation, the bait is cast, and the fishing rod is placed in a suitable rod holder (not shown) to be left unattended or minimally attended. If a fish nibbles or strikes the bait, a vibration signal such as a harmonic vibration is sensed as the line shakes the fishing rod with a particular signal. The vibration sensor 104 is tuned to recognize fish vibration, and to ignore oscillations generated by waves, or by live bait that may be attached to the line.

In one embodiment, the LED or other visual indicator 140 is green in a normal operating state, and turns to red in the event of a current fish nibble or strike. In one embodiment, if the fish nibble or strike event passes the LED or other visual indicator 140 turns to another color such as yellow. In one embodiment, if the fish nibble or strike event passes, the LED or other visual indicator 140 flashes yellow three times, with and with a three beep audible. This will happen three times spaced fifteen seconds apart for about a one minute total time limit. This is helpful while the user is away from the device. As discussed above, in selected embodiments, LED indicators are combined with audible indicators such as beeps provided by a buzzer. Although red, green and yellow colors are indicated, the invention is not so limited. Other colors or signal methods such as number of flashes etc. can be used to distinguish between the states of normal, currently striking, and missed strike.

In one embodiment, one or more of the states (normal, currently striking, and missed strike) are also communicated to the fisherman using the transmitter 130 to a remote device 300, an example of which is shown in FIG. 3. The remote device 300 may include corresponding LED's, buzzers, etc. In one embodiment, both the local mounted fish detection device 100 and the remote device alert the fisherman as to the state of fish activity.

FIG. 3 shows details of one embodiment of a remote device 300. In one embodiment, the remote device 300 includes a circuit board 310 with a number of components mounted on the circuit board 310. In one example, FIG. 3 shows a receiver board 312 mounted to the circuit board 310. Also shown in FIG. 3 is a chip 314, such as a processor or logic chip. Also shown in FIG. 3, a power switch 316 and a power source 318 such a battery. In one embodiment, a number of alert devices are shown, similar to embodiments described above. FIG. 3 illustrates both a visual alert device such as an LED 322, and an audible alert device 320 such as a piezo buzzer, although the invention is not so limited. In one embodiment, an external antenna 324 is included to aid in detecting a transmitted signal from the fish detection device, or to aid in transmitting information back to the fish detection device.

There are a number of advantages to embodiments as described above. In selected embodiments described above, the fishing line is not coupled to the device. This has advantages such as ease of use, and improved casting ability. In selected embodiments described above, a vibration sensor is used to detect only fish. The specially tuned vibration sensor is an improvement over a mere motion sensor, as the vibration sensor can ignore extraneous motion such as waves, bait, etc. In one embodiment, however a simple motion detector is included to detect potential theft of the fishing pole. In selected embodiments described above, multiple states of fish activity such as normal, currently striking, and missed strike are indicated to provide the fisherman with more detailed information that merely rod motion or no rod motion. Further, in selected embodiments described above, one or more fish activity states are transmitted to a remote device thus giving the fisherman more freedom to move about while the rod is left unattended.

Although a number of advantages are listed above, the list is not intended to be exhaustive. Other features and advantages of embodiments of the invention not listed above are provided to one of ordinary skill in the art, with the benefit of the present specification. Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and fabrication methods are used.

What is claimed is:

1. A fish detector, comprising:
a base portion to attach to a fishing pole apart from a fishing line;
a vibration sensing circuit coupled to the base portion;
an output signal generator to provide fish detection information;
a transmitter coupled to the base portion to send the fish detection information to a receiver remote from the fish detector.

2. The fish detector of claim 1, wherein the fish detection information includes current fish bite information and past fish bite information.

3. The fish detector of claim 1, wherein the output signal generator provides fish detection information both locally at the fishing pole and remotely to the receiver.

4. The fish detector of claim 3, wherein the output signal generator provides local fish detection information both through lighted signals and through audible signals.

5. The fish detector of claim 3, wherein the output signal generator provides remote fish detection information both through lighted signals and through audible signals.
